(19) United States
(12) Patent Application Publication
(10) Pub. No.: US 2011/0106734 A1
(43) Pub. Date: May 5, 2011

(54) SYSTEM AND APPARTUS FOR FAILURE PREDICTION AND FUSION IN CLASSIFICATION AND RECOGNITION

(76) Inventors: TERRANCE BOULT, Monoment, CO (US); Walter Scheirer, Colorado Springs, CO (US); Anderson De Rezende Rocha, Campinas (BR)

(21) Appl. No.: 12/766,283

(22) Filed: Apr. 23, 2010

Related U.S. Application Data
(60) Provisional application No. 61/172,333, filed on Apr. 24, 2009.
(60) Provisional application No. 61/246,198, filed on Sep. 28, 2009.

(51) Int. Cl. G06F 15/18; G06F 11/00

(52) U.S. Cl. 706/12; 714/47.3; 714/E11.02

(57) ABSTRACT

The present invention relates to pattern recognition and classification, more particularly, to a system and method for meta-recognition which can to predict success/failure for a variety of different recognition and classification applications. In the present invention, we define a new approach based on statistical extreme value theory and show its theoretical basis for predicting success/failure based on recognition or similarity scores. By fitting the tails of similarity or distance scores to an extreme value distribution, we are able to build a predictor that significantly outperforms random chance. The proposed system is effective for a variety of different recognition applications, including, but not limited to, face recognition, fingerprint recognition, object categorization and recognition, and content-based image retrieval system. One embodiment includes adapting machine learning approach to address meta-recognition based fusion at multiple levels, and provide an empirical justification for the advantages of these fusion element. This invention provides a new score normalization that is suitable for multi-algorithm fusion for recognition and classification enhancement.

### RELATED APPLICATIONS

The present invention claims priority on provisional patent application Ser. No. 61/172,333, filed on Apr. 24, 2009, entitled System and Apparatus for Failure Prediction and Fusion in Classification and Recognition and provisional patent application Ser. No. 61/246,198, filed on Sep. 28, 2009, entitled Machine-Learning Fusion-Based Approach to Enhancing Recognition System Failure Prediction and Overall Performance and both are hereby incorporated by reference.

### STATEMENT REGARDING FEDERALLY SPONSORED RESEARCH OR DEVELOPMENT

This invention was made with government support to under grant number N00014-08-1-0638, and STTR contract number N00014-07-M-0421 awarded by the Office of Naval Research and PFI grant number 0650251 awarded by the National Science Foundation. The government has certain rights in the invention.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF INVENTION

The present invention relates to pattern recognition and classification, more particularly, to a system and method for meta-recognition for a variety of different recognition and classification applications. Meta-recognition provides for the ability to predict or recognize when a system is performing correctly or failing.

We show that the theory of meta-recognition applies any general recognition problem. We then derive a statistical meta-recognition process and how it is effective for a variety of recognition applications, including face recognition, a fingerprint recognition, image categorization and recognition, as well as content-based image retrieval.

We also develop a new score normalization that is suitable for multi-algorithm fusion for recognition and classification enhancement.

We also introduce a machine-learning approach extends from this theory to consider alternative feature sets and addresses issues of non-independent data.

Various embodiments of the invention are demonstrated and evaluated shown for a variety of data sets across computer vision, including four different face recognition algorithms, a fingerprint recognition algorithm, a SIFT-based object recognition system, and a content-based image retrieval system. Although, we show applications related to images, those skilled in the art will see how this invention is equally applicable to other non image-based pattern recognition systems.

### BACKGROUND OF THE INVENTION

Computer-based Recognition vision is commonly defined as submitting an unknown object to an algorithm, which will compare the object to a known set of classes, thus producing a similarity measure to each. For any recognition system, maximizing the performance of recognition is a primary goal. In the case of general object recognition, we do not want an object of a class unknown to the system to be recognized as being part of a known class, nor do we want an object that should be recognized by the system to be rejected as being unknown. In the case of biometric recognition, the stakes are sometimes higher: we never want a mis-identification in the case of a watch-list security or surveillance application. With these scenarios in mind, we note that the ability to predict the performance of a recognition system on a per instance match basis is desirable for a number of important reasons, including automatic threshold selection for determining matches and non-matches, automatic algorithm selection for multi-algorithm fusion, and to signal for further data acquisition—all ways we can improve the basic recognition accuracy.

Meta-recognition is inspired by the multidisciplinary field of meta-cognition. In the most basic sense, meta-cognition [7] is “knowing about knowing”. For decades, psychologists and cognitive scientists have explored the notion that the human mind has knowledge of its own cognitive processes, and can use it to develop strategies to improve cognitive performance. For example, if you notice that you have more trouble learning history than mathematics, you “know” something about your learning ability, and can take corrective action to improve your academic performance. Meta-cognition, as a facilitator of cognitive performance enhancement, is a well documented phenomenon. Studies [5, 6] have shown that introspective test subjects exhibit higher levels of performance at problem solving tasks. Computational approaches to meta-cognition appear frequently in the artificial intelligence literature.

An overview of an example meta-recognition process is shown in FIG. 1. A recognition system (1) produces scores which are provided to the Meta-Recognition system (10) along with any other system monitoring information (20). If The Meta-Recognition system (10) predicts success the system completes operation for that input sample. If it predicts failure it can request operation interaction (30), perform fusion over different data or features (40), it can simply ignore this data (50) or can choose to acquire more data). The Meta-recognition system can the provide feeding back control information (70) to the underlying recognition system, e.g. to change acquisition parameters. The meta-recognition predictions, allow the overall system to take action to improve the overall accuracy of the recognition system. For instance, if the recognition system has failed to recognize the input image, we can, perform better fusion with other collected data by down-weighting or discarding the failing data, ignoring the data, or acquiring more data, giving the recognition system another attempt to recognize the input image successfully.

To formalize this concept we adapt a standard articulation of computational meta-cognition [4], to formally define our meta-recognition:

Definition 1 Let X be a recognition system. We define Y to be a meta-recognition system when recognition state information flows from X to Y, control information flows from Y to X, and Y analyzes the recognition performance of X, adjusting the control information based upon the observations.

The relationship between X and Y can be seen in FIG. 1, where X is the underlying recognition system (1) and Y is the “Meta-Recognition System (10)”. For meta-recognition Y can be any approximation of the cognitive process, including a statistical technique or machine learning techniques such as neural network or SVM. For score-based meta-recognition, a preferred embodiment of this invention, Y observes the recognition scores produced by X. Based on the analysis the meta-recognition system can predict the success/failure for other systems use or it can adjusts the recognition decisions, fuse data from multiple sources or and perhaps signal for a added information of specific response action. It can use the information to renormalize the scores so a natural way for predicting success/failure is to renormalize and then allow a later thresholding or fusion of the renormalized data.

Many heuristic approaches could be defined for the meta-recognition process and prior work exists that describes systems that are effectively weak forms of meta-recognition. Image or sample quality has long stood out as the obvious way of predicting recognition system performance and many systems incorporate control loops that use focus or image quality measures to optimize input for a recognition system. Meta-recognition differs because it uses results from the recognition process, not just measures from the direct input. In prior work use of data has been called post-recognition score analysis.

FIG. 1 depicts the general process, with the analysis occurring after the system has produced a series of distance or similarity scores for a particular match instance. These scores are used as input into a predictor, which will produce a decision of recognition success or failure. This post-recognition classifier can use a variety of different techniques to make its prediction, including distributional modeling and machine learning. Based on the decision of the classifier and not on the original recognition result, action can be taken to lift the accuracy of the system, including enhanced fusion, further data acquisition, or prompting an operator to intervene. In some cases, the system will be run again to attain a successful recognition result.

Thus far, a theoretical explanation of why post-recognition score analysis is effective for per instance prediction has yet to be presented. In this invention, we develop a statistical theory of post-recognition score analysis derived from the extreme value theory. This theory generalizes to all recognition systems producing distance or similarity scores over a gallery of known images. Since the literature lacks a specific term for this sort of prediction, we term this work meta-recognition. This invention uses this theory of meta-recognition to develop a new statistical test based upon the Weibull distribution that produces accurate results on a per instance recognition basis. An alternative embodiment uses a machine learning approach, developing a series of fusion techniques to be applied to the underlying features of the learning, thus producing even more accurate classifiers. Further, we explain why machine learning classifiers tends to outperform statistical classifiers in some cases.

### DESCRIPTION OF THE RELATED ART

Peirce and Ahern (US 20070150745) have presented a system for biometric authentication that includes an audit function that is configured to monitor the performance of the system over a defined time period. The authentication system includes a matching system providing as an output a score-based comparison of the presented and stored biometrics. In such solution, the authors propose to audit a biometric system using predefined parameters to select an appropriate threshold score from a plurality of available threshold scores namely user population type, user gender, user age, biometric sample type among others. This system is different from ours in the sense we do not assume anything regarding the underlined data and the proposed invention does not require prior information regarding data distribution or class distributions. Our system analyzes failures based solely on the score distributions from the authentication and/or classification system.

Some solutions in the literature have been proposed to predict failure using classifiers. Keusey, Tutunjian, and Bitetto (AG06F1100FI) have presented a simple model to analyse log events in a system, learn the behavior of positive and negative events, use machine learning classification and predict failure. A similar solution to AG06F1100FI was proposed by Smith (U.S. Pat. No. 6,948,102) where the author analyzes data storage logs, scale and threshold them, and feed a probabilistic neural network for failure prediction. Such approaches, however, are more suitable for scenarios where positive and negative examples are extensive and make the learning an easier task. In our solution, we are able to predict failures even with only one example using the power of extreme value prediction.

Billet and Thumrugoti (US 20030028351) have proposed a system for pattern classification and failure prediction that employs a library of previously learned patterns. Given an input example, it analyzes it and uses several data mining approaches to find in its database the most similar case. Then use such info to forecast the outcome. In a similar work, Moon and Torossian (US 20030177118) have proposed to use data mining techniques upon a base of profiles to perform failure prediction. Conversely, in our solution, we do not have a library of learned patterns. In most cases, we only have the example at hands and no prior knowledge.

Gullo, Musil, and Johnson (U.S. Pat. No. 6,684,349) have proposed a system and method for reliability assessment and prediction of end items using Weibull distributions. The reliability of the new equipment is performed analyzing the similarities and differences between the new equipment and predecessor equipments. The predecessor end item field failure data is collected and analyzed to compare the degree of similarity between the predecessor fielded end item and the new design. Kitada, Aoki, and Takahashi (US 2005/0027486 A1) have presented a similar solution for failure prediction in printers. Using Weibull distributions and previously annotated failures, the system is able to predict if a printer is about to fail. Different from both solutions, in our case, we not have the patterns of predecessor failure examples. Often, we have only the example to be analyzed in the biometric or classification system.

Geusebroek (WO 2007/004864) has proposed a method for visual object recognition using statistical representation of the analyzed data. More particularly, he presents an approach for color space representation using histogram-based invariants (probabilities). Afterwords, such histograms are characterized using Weibull distributions or any other similar statistical model (e.g., GMMs). In WO 2007/004864, the author perform a probability transformation of the color space and then use Weibulls distribution to summarize the data. To assess the difference between two local histograms, fitted by a Weibull distribution, a goodness-of-fit test is performed. For that, the author proposed the use of the well-known integrated error between the cumulative distributions obtained by Crammer-von-Mises statistics. For failure prediction it is not straightforward to compare distributions of failure and non-failure, therefore it is not possible to use direct cumulative distributions comparisons. This work is not directly related to biometrics, nor does it encompass Weibull-based failure prediction that can be used for biometric systems.

Riopka and Boult (U.S. Provisional Patent Application 60/700,183) have presented a system also introduced in [10], and subsequently used for a variety of biometric failure prediction applications in [16, 17, 18], that uses a machine learning-based failure prediction from recognition scores. In essence, this technique uses machine learning to learn matching and non-matching biometric score distributions based on sorted recognition/distance scores, in order to construct a classifier that can return a decision of recognition failure or recognition success. Machine learning requires a great deal of training data, and, depending on the machine learning algorithm chosen, can take a very long time to train. 60/700,183 makes use of eye perturbations as part of its feature process for learning as well. The system presented here extends that concept to allow perturbations in the statistical approach presented as well as new types of fusion on-top of perturbations. Effective machine learning needs data which perturbations can help address.

In the research literature, not much has been written directly on the topic of predicting failure in recognition systems, beyond the work on image quality metrics. Where we do find similar work is in the topic of modeling matching and non-matching score distributions of recognition and verification systems for biometrics. Cohort analysis [2] is a post-verification approach to comparing a claimed probe against its neighbors. By modeling a cohort class (the distribution of scores that cluster together at the tails of the sorted match scores after a probe has been matched against a pre-defined “cohort gallery”), it is possible to establish what the valid “score neighbors” are, with the expectation that on any match attempt, this probe will be accompanied by its cohorts in the sorted score list with a high degree of probability. In a sense, the cohort normalization predicts failure by determining if a claimed probe is straying from its neighbors.

Similar to the idea of cohorts, the notion of Doddington's Zoo has been well studied for biometrics [14, 15]. The zoo is composed of score distributions for users who are easy to match (sheep), difficult to match (goats), easily matched to (lambs), and easily matched against others (wolves). Failure conditions arise when goats have difficulty matching, and when wolves match against lambs (or sheep). In order to compensate for these failures, [14, 15] propose modeling the zoo's distributions, and normalizing with respect to the group-specific class being considered.

In line with the distributional modeling above, but closer to the goal of failure prediction with extreme value theory we present, [20] chooses to model genuine and impostor distributions using the General Pareto Distribution. This work makes the important observation that the tails of each distribution contain the data most relevant to defining each (and the associated decision boundaries), which are often difficult to model—thus the motivation for using extreme value theory. However, the choice of GPD is motivated by the Pickands-Balkema-de Haan Theorem, which states that for a high enough threshold, the data above the threshold will exhibit generalized Pareto behavior. This suggests that the size of the tails is bounded by a high threshold, which may not reflect their true nature. It is also unclear if biometric scores are suitable for a Pareto distribution that converges as the threshold approaches infinity.

### SUMMARY OF THE INVENTION

Techniques, systems, and methods for meta-recognition which can be used for predicting success/failure in classifier and recognition systems are described. Embodiments of the present invention also include a statistical test procedure, a new score normalization that is suitable for multi-algorithm fusion for recognition and classification enhancement, and machine-learning techniques for classification and for fusion.

### BRIEF DESCRIPTION OF THE DRAWINGS

The following list of figures conceptually demonstrates some embodiments of the invention, namely classification and recognition failure prediction and reports some experimental results using the aforementioned embodiments.

FIG. 1 An overview of a meta-recognition process.

FIG. 2 Main elements of a statistical analysis based meta-recognition system

FIG. 3 Main elements of a machine-learning-based meta-recognition system

FIG. 4 Main elements of a method for meta-recognition-based fusion

FIG. 5. The match and non-match distributions. A threshold t₀ applied to the score determines the decision for accept or reject. Where the tails of the two distributions overlap is where we find False Rejections and False Accepts.

FIG. 6. EVT-based meta-recognition for failure prediction.

FIG. 7. Six different Weibulls recovered from real-matches (from the finger li set of BSSR1), one is a failure (not rank-1 recognition), 5 are successes. Note the changes in both shape and position. Can you identify which one is for a failure? Hint: it's not black, cyan, purple, blue or red. The system gets all of them correct. When it comes to predicting failure, Weibulls wobble but they don't fall down.

FIG. 8. MRET curves for comparing GEVT, reversed Weibull- and Weibull-based predictions using the BSSR1 dataset algorithms face C and face G. Weibull clearly outperform the more general GEVT. Weibull and reversed Weibull are close.

FIG. 9. MRET curves for the EBGM face recognition algorithm. Tail sizes used for Weibull fitting vary from 25 scores to 200 scores. The data set for this experiment is the entire FERET set. Rank 1 recognition for this experiment is 84.2%.

FIG. 10. MRET curves for a leading commercial face recognition algorithm. Tail sizes used for Weibull fitting vary from 5 scores to 50 scores. The data set for this experiment is FERET DUP1. Rank 1 recognition for this experiment is 39.7%.

FIG. 11. MRET curves for the multi-biometric BSSR1 set. Rank 1 recognition for face recognition algorithm C is 89.4%, 84.5% for face G, 86.5% for finger li, and 92.5% for finger ri.

FIG. 12. MRET curves for the larger individual BSSR1 algorithm score sets. Rank 1 recognition for face recognition algorithm C is 79.8%, 76.3% for face G, 81.15% for finger li, and 88.25% for finger ri.

FIG. 13 MRET curves for the SIFT object recognition approach, using EMD as the distance metric. The data set for this experiment is the illumination direction subset of ALOI. Rank 1 recognition was for this experiment is 45.4%.

FIG. 14. MRET curves for four content-based image retrieval approaches. The data set for this experiment is “Corel Relevants”. Rank 1 recognition for BIC is 83.7%, 73.2% for CCV, 71.6% for GCH, and 68.7% for LCH.

FIG. 15. CMC comparing the two-algorithm multi-modal fusion of the W-scores and the z-scores for the multi-biometric data set of BSSR1. Better recognition performance is noted in all comparisons for the W-scores. Both normalizations show improvement from the baseline.

FIG. 16. CMC comparing the two-algorithm CBIR fusion of the W-scores and the z-scores for the “Corel Relevants”. Better recognition performance is noted in all comparisons for the W-scores. Both normalizations show improvement from the baseline.

### DETAILED DESCRIPTION OF THE INVENTION

### 1 Introduction

For any recognition system in computer vision, the ability to predict when the system is failing is very desirable. Often, it is the input imagery to an active system that causes the failing condition—by predicting failure, we can obtain a new sample in an automated fashion, or apply corrective image processing techniques to the sample. At other times, one algorithm encounters a failing condition, while another does not—by predicting failure in this case, we can choose the algorithm that is producing the accurate result. Moreover, the general application of failure prediction to a recognition algorithm allows us to study its failure conditions, leading to necessary enhancements.

In this patent, we formalize the meta-recognition and its use for success/failure prediction technique in recognition systems. The present invention is appropriate for any computer-enhanced recognition system that produces recognition or similarity scores. We also develop a new score normalization technique, called the W-score, based on the foundation laid by our theoretical analysis. We show how to use expand machine-learning technique to address the meta-recognition problem and how either or both of these techniques can be used for fusion. We briefly review the three major classess of system that can be supported by this meta-recogniton approach:

FIG. 2 shows the main elements of a statistical analysis based meta-recognition system, in which enrollment samples (100) from a recognition system are gathered into a recognition gallery (110). For a particular subject (120) we obtain a probe sample (130). We the and compare (140) the results of probe sample and the recognition gallery to produce a set of recognition scores (150). As will be describe in some detail later we use a statistical extreme value analysis (160), e.g. Weibull fitting, to a subset of the recognition scores. We can use the results of the statistical analysis to predict success/failure directly or to normalize the data and then allow a user threshold to be used for prediction.

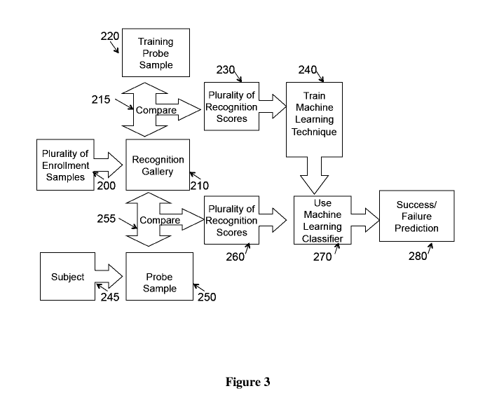

FIG. 3 shows the main elements of a machine-learning-based meta-recognition system. The process begins by gathering enrollments samples (200) to build the recognition gallery (210). To building the machine learning-based classifier we take training probe samples (220) and for each we generate recognition scores (230) by comparing it with the recognition gallery (210). Using this, and the knowledge of the actual identity of the training probe, we can then train a machine learning technique (240). For operational use, we then obtain a probe sample (250) from a subject which is compared with the recognition gallery (210) to generate recognition scores (260) which are processed by the machine learning-based classifier (270) to produce the success/failure prediction (280) or a normalization of the recognition scores.

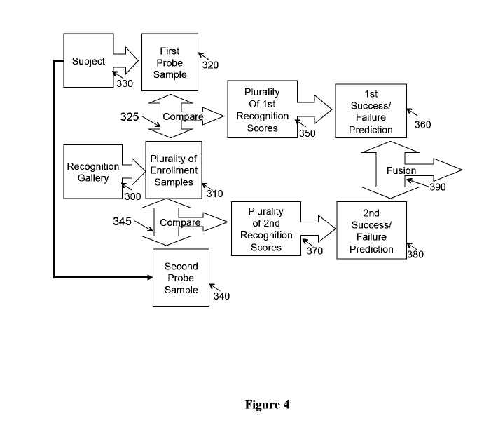

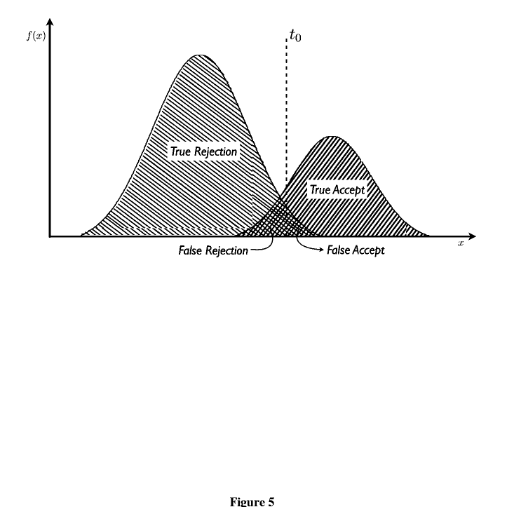

FIG. 4 shows the main elements of a method for meta-recognition-based fusion. In this approach the recognition gallery (300) containing the enrollment samples (310) is compared with a first probe sample (320) from a subject producing a first set of recognition scores (350) and a success/failure prediction or renormalization (360) for that first probe. It is also compared to a second probe sample (340) from the same subject (330) producing a second set of recognition scores (370)) and second set of success/failure prediction or normalization (380) which can then be fused (390). Fusion can be as simple as selection of one component based on confidence, summing normalized data or more complex processing combining the meta-recognition results with other data.

This invention discloses how to build various embodiments of these useful systems. The rest of this description is structured as follows. In Section 2, we define the problem of failure prediction for recognition systems, and review the previous machine learning approaches that have been applied to the problem. In Section 3, we present our statistical analysis with extreme value theory, introducing the Weibull distribution as the correct model for the data to be considered. Finally, in Section 4, we use the Weibull model as a predictor, and show results for experiments on four different possible embodiments of our solution: face recognition, fingerprint recognition, object recognition system, and Content-based Image Retrieval (CBIR) system. Further, we show improved recognition results using our W-score fusion approach across a series of biometric recognition algorithms and a series of CBIR techniques. In Section 5 we introduced the class of machine learning embodiments, feature-fusion for enhancing performance, and demonstrate effectiveness on the same sets of data. We end the description with section 6 that discusses the relative advantages of the statistical and machine-learning based embodiments.

### 2 Recognition Systems and Previous Learning Approaches

There are multiple ways to define “recognition” tasks. In [21], they define biometric recognition as a hypothesis testing process. In [19], they define the task of a recognition system to be finding the class label c*, where pₖ is an underlying probability rule and p₀ is the input image distribution, satisfying

$${c}^{*} = {argmax}_{Class c} Pr ( {p}_{0} = {p}_{c} ) \qquad ( 1 )$$

subject to Pr (p₀=p_{c}*)≧1−δ for a given confidence threshold δ, or to conclude the lack of such a class (to reject the input). The current invention is not restricted to biometric or images so we use the term “data samples” for the input (rather than image distribution) which could include 3D data (e.g. medical images), 2D data (images including biometrics), or 2D data (e.g. sound, text). We refer to the set of data that defines the class of items to be recognizes as the gallery, and data use to define the gallery is the enrollment samples. Probe samples refer to the data which is then tested for identity.

This invention, like many systems replace, the formal probability in the above definition with a more generic “recognition score,” which produces the same order of answers when the posterior class probability of the identities is monotonic with the score function, but need not follow the formal definition of a probability. In this case, setting the minimal threshold on a score effectively fixes δ. We call this rank-1 recognition, because if we sort the class scores or probabilities, recognition is based on the largest score. One can generalize the concept of recognition, as is common in object recognition, content-based image retrieval and some biometrics problems, by relaxing the requirement for success to having the correct answer in the top K. While we describe a “larger is better” approach, some researchers use a pseudo-distance measure where smaller scores are better. Those skilled in the art will see how to adapt such a measure, or invention described herein, to work together

For analysis, presuming ground-truth is known, one can define the match and non-match distributions [8, 24, 21], (see FIG. 5). For an operational system, a threshold t₀ on the similarity score s is set to define the boundary between proposed recognition accepts and proposed recognition rejections. Where t₀ falls on each tail of each distribution establishes where False Rejections (the probe exists in the gallery, but is rejected) or False Accepts (the probe does not exist in the gallery, but is accepted) will occur. In terms of failure, False Rejection is statistical Type II error, while False Acceptance is statistical Type I error. The question at hand is: how can we predict, in some automated fashion, if the result is a failure or a success?

The work in [17] addresses failure prediction using learning and a “Similarity Surface” S described as an n-dimensional similarity surface composed of k-dimensional feature data computed from recognition or similarity scores. S can be parametrized by n different characteristics, and the features can be from matching data, non-matching data, or some mixture of both. An empirical theorem is proposed in [17] suggesting that the analysis of that surface can predict failure:

Similarity Surface Theorem, Thm 1 from [17]. For a recognition system, there exists S, such that surface analysis around a hypothesized “match” can be used to predict failure of that hypothesis with high accuracy.

The post-recognition score analysis used in [10, 16, 17, 18] relies on an underlying machine learning system for prediction. Classifiers are trained using feature vectors computed from the data in the tails of the matching and non-matching distributions. Multiple techniques have been used to generate features, including Daubechies wavelets [16], DCT coefficients [17, 18], and various “delta features” (finite difference between similarity scores) [17, 18]. Experimentation in [17] showed the delta feature to be the best performing. In all of these works, the similarity scores are sorted, and if multiple views are available (as in [17]), the best score across the multiple views of the same gallery are the only ones considered in sorting. The classification in all these works proceeds in a binary fashion: the probe's feature vector derived from the sorted score list is submitted to the classifier, which predicts success or failure.

The question of why the features computed from the tails of the mixed matching and non-matching scores produce good prediction results has not been addressed by the prior work. However, several of those works report that supplying feature vectors composed of raw scores to the machine learning does not work. This patent provides a solid foundation for why the tails can predict failure; we hypothesize that the learning works because the feature chosen induces a normalizing effect upon the data. The results of machine learning in [10] [16] [17] [18] are indeed compelling, but no formal explanation of the underlying post-recognition similarity surface analysis theory is provided. Thus, the purely empirical treatment of Theorem 1 leads us to pursue a more formal statistical analysis.

### 3 The Theoretical Basis of Meta-Recognition and Failure Prediction from Recognition Scores

Almost any recognition task can be mapped into the problem of determining “match” scores between the input data and some class descriptor, and then determining the most likely class [19]. The failure of the recognition system occurs when the match score is not the top score (or not in the top K, for the more general rank K-recognition). It is critical to note that failure prediction is done for a single sample and this assessment is not based on the overall “mach/non-match” distributions, such as those in [21, 8] which include scores over many probes, but rather it is done using a single match score mixed in with a set of non-match scores. The inherent data imbalance, 1 match score compared with N non-match scores, is a primary reason we focus on predicting failure, rather than trying to predict “success”.

We can formalize failure prediction for rank-K recognition, as determining if the top K scores contain an outlier with respect to the current probe's non-match distribution. In particular, let us define [symbol] (p) to be the distribution of the non-match scores that are generated when matching probe p, and m(p) to be the match score for that probe. Let S(K)=s₁ . . . s_{K} be the top K sorted scores. Then we can formalize the null hypothesis H₀ of failure prediction for rank-K recognition as:

H₀(failure):∃xεS(K):x∉ [symbol] (p),

H₁(success):∀xεS(K),xε [symbol] (p), (2)

If we can confidently reject H₀(failure), then we predict success.

While some researchers have formulated recognition as hypothesis testing given the individual class distributions [19], that approach presumes good models of distributions for each match/class. Again, we cannot effectively model the “match” distribution here, as we only have 1 sample per probe, but we have n samples of the non-match distribution—generally enough for a good model and outlier detection.

As we seek a more formal approach, the critical question then becomes how to model [symbol] (p), and what hypothesis test to use for the outlier detection. Various researchers have investigated modeling the overall non-match distribution [8], developing a binomial model. Our goal, however, is not to model the whole non-match distribution over the whole population, but rather to model the tail of what exists for a single probe comparison. The binomial models developed by [8] account for the bulk of the data, but have problems in the tails.

An import observation about our problem is that the non-match distribution we seek to model is actually a sampling of scores, one or more per “class”, each of which is itself a distribution of potential scores for this probe versus the particular class. Since we are looking at the upper tail, the top n scores, there is a strong bias in the samplings that impact our tail modeling; we are interested only in the largest similarity scores.

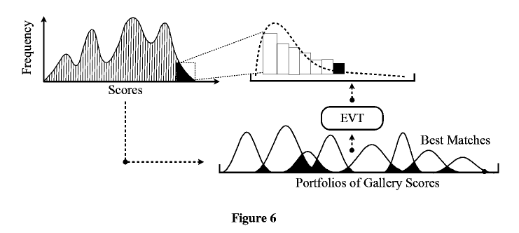

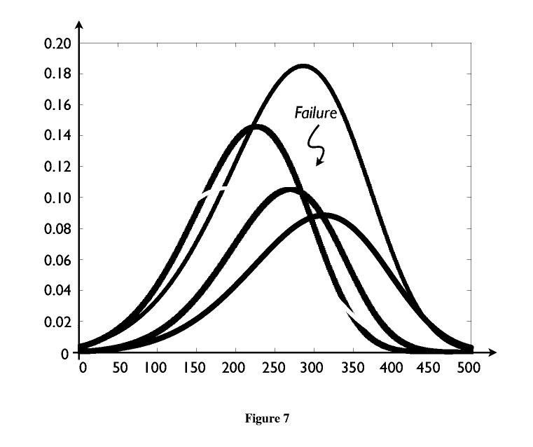

To see that recognition is an extreme value problem in a formal sense, we can consider the recognition problem as logically starting with a collection of portfolios, each of which is an independent subset of the gallery or recognition classes. This is shown in FIG. 6. From each portfolio, we can compute the “best” matching score in that portfolio. We can then collect a subset of all the scores that are maxima (extrema) within their respective portfolios. The tail of the post-match distribution of scores will be the best scores from the best of the portfolios. Looking at it this way we have shown that modeling the non-match data in the tail is indeed an extreme value problem.

Extreme value distributions are the limiting distributions that occur for the maximum (minimum) of a large collection of random observations from an arbitrary distribution. Gumbel [9] showed that for any continuous and invertible initial distribution, only three models are needed, depending on whether you are interested in the maximum or the minimum, and also if the observations are bounded above or below. Gumbel also proved that if a system/part has multiple failure modes, the time to first failure is best modeled by the Weibull distribution. The resulting 3 types of extreme value distributions can be unified into a generalized extreme value distribution given by:

$$G E V ( t ) = \{ \begin{matrix}\frac{1}{λ} {e}^{- {v}^{- 1 / k}} {v}^{- ( 1 / k + 1 )} & k \neq 0 \\ \frac{1}{λ} {e}^{- ( x + {e}^{- x} )} & k = 0\end{matrix} \qquad ( 3 )$$

where

$$x = \frac{t - τ}{λ} , v = ( 1 + k \frac{t - τ}{λ} )$$

where k, λ, τ are the shape, scale and location parameters respectively. Various values of the shape parameter yield the extreme value type I, II, and III distributions. Specifically, the three cases k=0, k>0, and k<0 correspond to the Gumbel (I), Frechet (II), and Reversed Weibull (III) distributions. Gumbel and Frechet are for unbounded distributions and Weibull for bounded. The extreme value theorem is analogous to a central-limit theorem, but with minima/maxima for “first failures”.

If we presume that match scores are bounded, then the distribution of the minimum (maximum) reduces to being a Weibull (Reversed Weibull) [12], independent of the choice of model for the individual non-match distribution. For most recognition systems, the pseudo-distance or similarity scores are bounded from both above and below. If the values are unbounded, the GEV distribution can be used.

Rephrasing, no matter how we want to model each person's non-match distribution, be it truncated binomial, a truncated mixture of Gaussians, or even a complicated but bounded multi-modal distribution (the closest failures, if we select the observed minimum scores from these distributions), the sampling always results in a Weibull distribution.

Given the potential variations that can occur in the class for which the probe image belongs, there is a distribution of scores that can occur for each of the classes in the gallery. As shown in FIG. 6, we can view the recognition of a given probe image as implicitly sampling from these distributions. Our failure-prediction takes the tail these scores, most of which are likely to have sampled from the extreme of their underlying distribution, and fits a Weibull distribution to that data. Given the Weibull fit to the data, we can then determine if the top score is an outlier, by considering the amount of the CDF that is to the left of the top score.

While the base EVT shows Weibull or Reverse Weibull models are the result of distributions bounded from below and from above respectively, there is no analysis given for models which, like recognition problems, are bounded from both above and below. In our experimental analysis we decided to test both Weibulls, Reversed Weibulls (via differences) and the GEV. Note that the GEV, with 3 parameters rather than 2, requires more data for robust fitting. For clarity in the remainder of the discussion we use the term Weibull, but recognize it could be replaced by Reversed Weibull or GEV in any of the processes. We also attempted to test General Pareto Distributions, as implemented in Matlab, but they failed to converge given the small size of data in our tails.

Weibull distributions are widely used in lifetime analysis (a.k.a component failure analysis) and in safety engineering. It has been reported that “The primary advantage of Weibull analysis is the ability to provide reasonably accurate failure analysis and failure forecasts with extremely small samples.” [1], with only 1-3 failure examples to model failures for aircraft components, for example. Various statistical toolboxes, including Matlab, Mathematica, R, and various numerical libraries in C and Fortran, among others, have functions for fitting data to a Weibull. Many, including Matlab, also provides an inverse Weibull and allows estimating the “confidence” likelihood of a particular measurement being drawn from a given Weibull, which is how we will test for “outliers”. The PDF and CDF of a Weibull are given by:

$$C D F ( t ) = 1 - {e}^{- {( \frac{t}{α} )}^{γ}} ; P D F ( t ) = \frac{γ}{t} {( \frac{t}{α} )}^{γ} {e}^{- {( \frac{t}{α} )}^{γ}}$$

As mentioned above there is also a reversed Weibull for dealing with maxima, but with a bounded maximum M one can also just apply the standard Weibull to the differences, M−s.

### 3.1 Weibull-Based Statistical Meta-Recognition

As we propose to use the consistency of the EVT/Weibull model of the non-match data to the top scores, an issue that must be addressed in Weibull-based failure prediction is the impact of any outliers on the fitting. For rank-1 fitting this bias is easily reduced by excluding the top score and fitting to the remaining n−1 scores from the top n. If the top score is an outlier (recognition worked), then it does not impact the fitting. If the top score was not a match, including the recognition in the fitting will bias the distribution to be broader than it should, but will also increase the chance that the system will predict the top score is a failure. For rank-K recognition we employ a cross-validation approach for the top-K elements, but for simplicity herein we focus on the rank-1 process. We must also address the choice of n, the tail size to be used.

Given the above discussion we can implement (FIG. 6) rank-1 meta-recognition (failure prediction) as:

Algorithm 1 Rank-1 Statistical Meta-Recognition.

Require: A collection of similarity scores S

| | |
|---|---|
| 1: | Sort and retain the n largest scores, s₁,...,sₙ ∈ S; |
| 2: | Fit a GEV or Weibull distribution W to s₂,...,sₙ, skipping the |
| | hypothesized outlier; |
| 3: | if Inv(W(s₁)) > ∈ then |

| | |
|---|---|
| 4: | s₁ is an outlier and we reject the failure prediction (null) |
| | hypothesis H₀. |

| | |
|---|---|
| 5: | end if |

In this embodiment, ε is our hypothesis test “significance” level threshold, and while we will show full MRETs (described in Sec. 4), good performance is often achieved using ε=0.99999999. It is desirable that the invention does not make any assumptions about the arithmetic difference between matching and non-matching scores. If we needed such an assumption of high arithmetic difference among the match and non-match scores, we would not need a classification algorithm—a simple threshold would suffice. The current invention shows good performance in many different scenarios—even with scores that are almost tied.

The GEV distribution is a 3 parameter family: one parameter shifting its location, one its scale and one that changes its shape. The EVT theory provides the reason why prior adhoc “learning-based” approaches [10, 17] were successful. The learning could develop an implicit overall Weibull model's shape parameter, ignoring any shift since their features are shift-invariant, and effectively test the outlier hypothesis. The failure of those learning-based approaches on the raw data is likely caused by the shifting of [symbol] (p) as a function of p. Given the above, one can see that the ad-hoc (and unproven) “similarity surface theory” cited above is in fact just a corollary to the Extreme Value Theory, adapted to biometric recognition results.

### 3.2 W-Scores

Failure prediction is only one use of our Weibull/GEV fitting. A second usage of this fitting is to introduce a new normalization of data to be used in fusion. The idea of normalizing data before some type of score level fusion is well studied, with various norms ranging from z-scores, t-scores and various ad-hoc approaches. We introduce what we call the W-score, for Weibull score normalization, which uses the inverse Weibull for each score to re-normalize data for fusion. In particular, let v_{j,c} be the raw score for algorithm/modality j for class c, and define its W-score as w_{j,c}=CDFWeibull(v_{j,c}; Weibull(Sⱼ(K))), wherein Sⱼ(K) is the sorted scores for algorithm/modality j, and Weibull( ) is the Weibull fitting process describe above.

The W-score re-normalizes the data based on its formal probability of being an outlier in the extreme value “non-match” model, and hence its chance of being a successful recognition. We then define W-score fusion with f_{c}=Σⱼ w_{j,c}. Alternatively, similar to Equation 1, one can consider the sum only of those items with a W-score (probability of success) above some given threshold.

### 4 Analysis of Statistical Meta-Recognition

Evaluation of meta-recognition need to consider both the accuracy of recognition as well as the meta-recognition. To compare the results we use a “Meta-Recognition Error Trade-off Curve” (MRET) [17], which can be calculated from the following four cases:
1. “False Accept”, when the meta-recognition prediction is that the recognition system will succeed but the rank-1 score is not correct.
2. “False Reject”, when the meta-recognition predicts that the recognition system will fail but rank-1 is correct.
3. “True Accept”, when both the recognition system and the meta-recognition indicate a successful match.
4. “True Reject”, when the meta-recognition system predicts correctly that the underlying recognition system is failing.

We calculate the Meta-Recognition False Accept Rate (MRFAR), the rate at which meta-recognition incorrectly predicts success, and the Meta-Recognition Miss Detection Rate (MRMDR), the rate at which the meta-recognition incorrectly predicts failure, as

$$MRFAR = \frac{\vert {C}_{1} \vert}{\vert {C}_{1} \vert + \vert {C}_{4} \vert} , MRMDR = \frac{\vert {C}_{2} \vert}{\vert {C}_{2} \vert + \vert {C}_{3} \vert} . \qquad ( 4 )$$

The MRFAR and MRMDR can be adjusted via thresholding applied to the predictions, to build the curve. Just as one uses a traditional DET or ROC curve to set recognition system parameters, the meta-recognition parameters can be tuned using the MRET. This representation is a convenient indication of Meta-Recognition performance, and will be used to express all results presented in this patent.

This first experimental analysis was to test which of the potential GEV models are more effective predictors and to determine the impact of “tail” size on the results. The second set of experiments was to allow comparison with the learning-based failure prediction results presented in [17] and [18]. We then present experiments showing failure prediction for non-biometric recognition problems. Finally, we show the use of W-score fusion on multiple application areas.

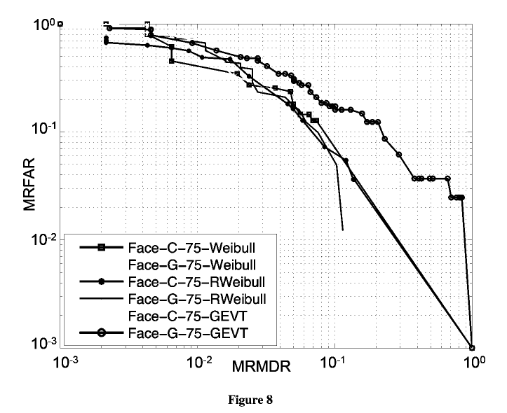

To analyze the choice of model, including Weibull, inverse Weibull, and GEVT, we used the face-recognition algorithms from the NIST BSSR1¹ multi-biometric score set. We show the comparison in FIG. 8, and conclude that for these problems Weibull fitting is more effective in predicting failure. We also consider the tail size, shown in subsequent plots, with the best performing size found to be a function of gallery size. In the remaining experiments we use the notation DATA-tail-size to show the tail size used for the various plots. ¹http://www.cs.colostate.edu/evalfacerec/

For the second round of failure prediction experiments, we tested a series of biometric recognition algorithms, including the EBGM [13] algorithm from the CSU Facial Identification Evaluation System², a leading commercial face recognition algorithm, and the two face recognition algorithms and fingerprint recognition algorithm of the NIST BSSR1 multi-biometric score set. ²http://www.itl.nist.gov/iad/894.03/biometricscores/

EBGM and the commercial algorithm were tested with data from the FERET³ data set. We chose to run EBGM over a gallery consisting of all of FERET (total gallery size of 3,368 images, 1,204 unique individuals), and the commercial algorithm over a gallery of just the more difficult DUP1 (total gallery size of 1,239 images, 243 unique individuals) subset. The BSSR1 set contains 3,000 score sets each for two face recognition algorithms, and 6,000 score sets each for two sampled fingers for a single fingerprint recognition algorithm (each gallery consists of the entire set, in an “all vs. all” configuration). Of even more interest, for the W-score fusion shown later on in this section, is BSSR1's multi-biometric set, which contains 517 score sets for each of the algorithms, with common subjects between each set. ³http://www.itl.nist.gov/iad/humanid/feret/

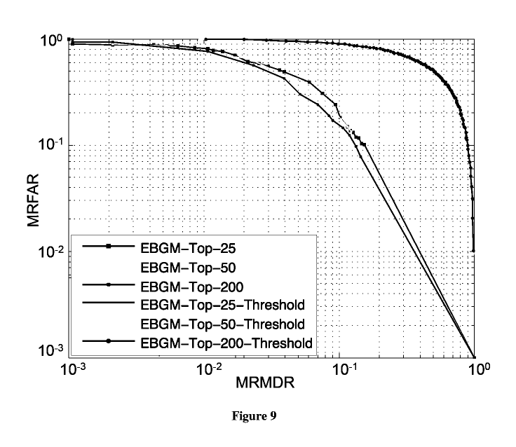

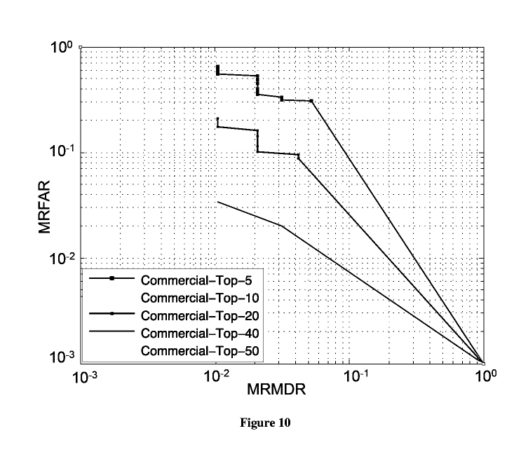

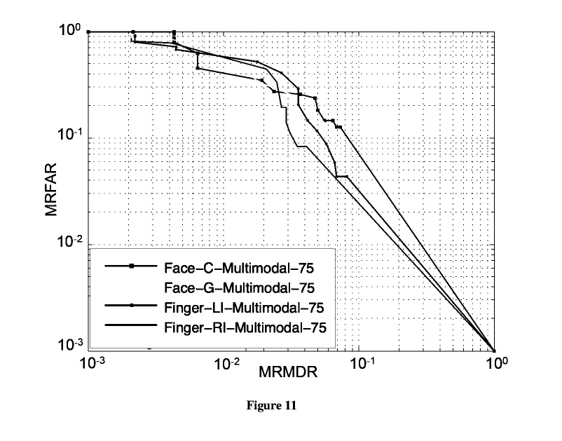

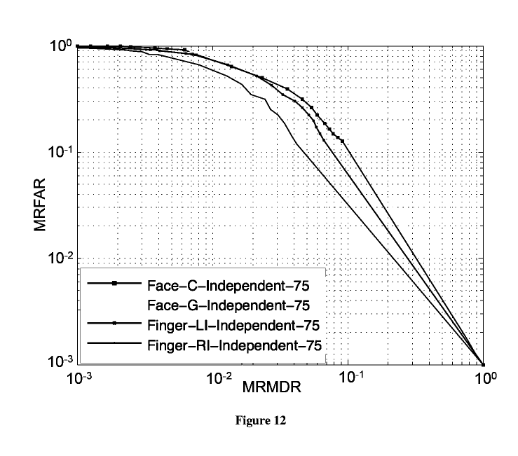

The MRETs for each of these experiments are shown in FIGS. 9-12. We show a variety of different tail sizes for plots 9 and 10, and the best performing tail sizes for plots. For comparison, the data for a random chance prediction is also plotted on each graph for all experiments. Weibull fitting is comparable to the results presented in [17] and [18] for machine learning, without the need for training.

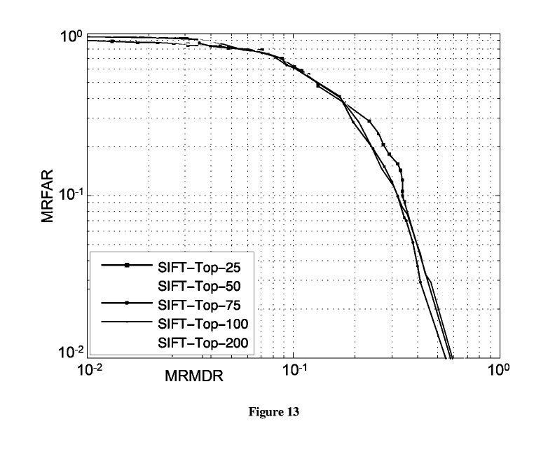

For the second round of more general object recognition failure prediction experiments, we tested a SIFT-based approach⁴ [11] for object recognition on the illumination direction subset of the ALOI⁵ set (1,000 unique objects, 24 different illumination directions per object). We also tested four different content-based image retrieval approaches [3] on the “Corel Relevants⁶” data set composed of 50 classes with 1,624 images, with a varying distribution of images per class. The MRETs for each of these experiments are shown in FIGS. 13 & 14. ⁴http://www.cs.ubc.ca/lowe/keypoints/⁵http://staff.science.uva.nl/aloi/⁶http://www.cs.ualberta.ca/mn/BIC/bic-sample.html

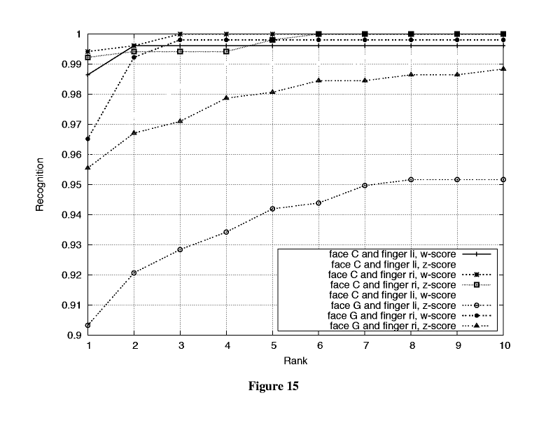

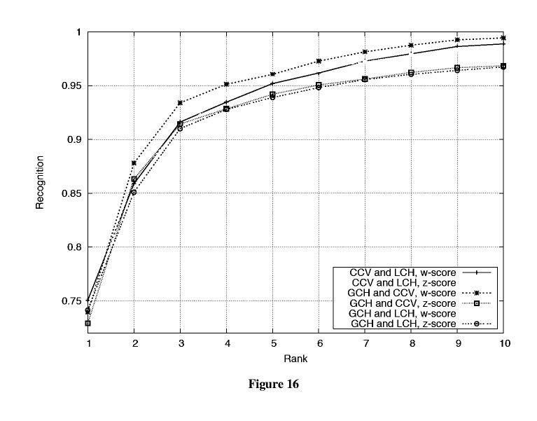

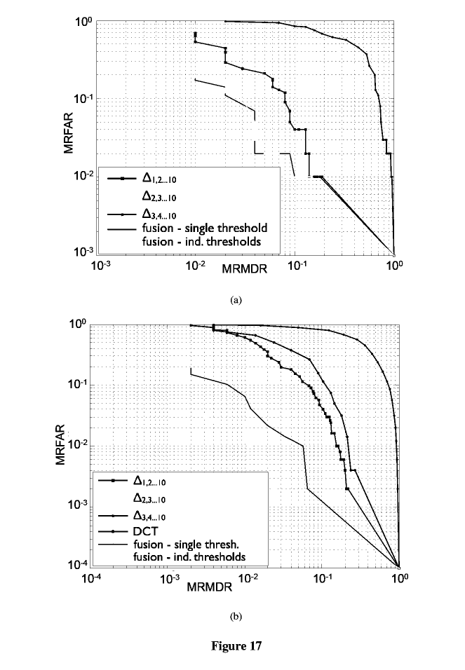

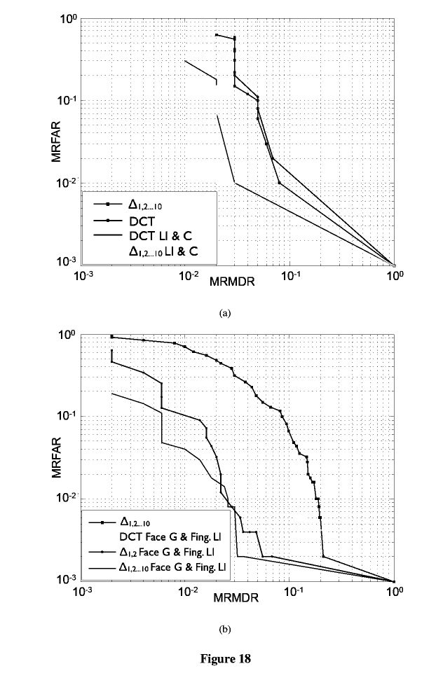

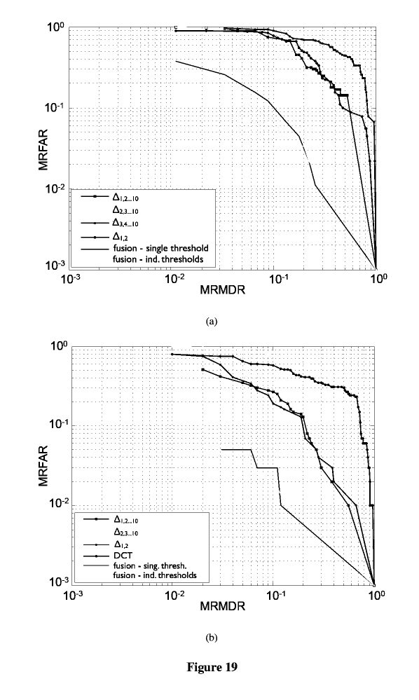

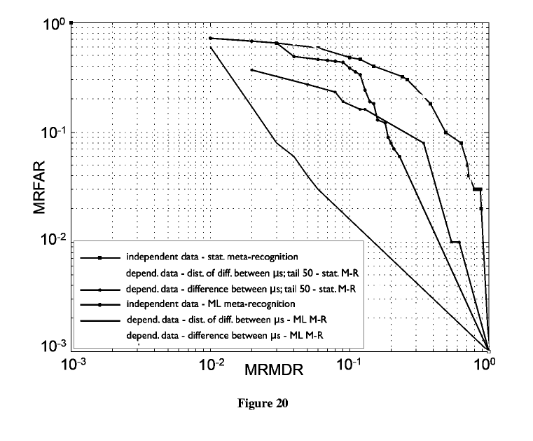

To test the viability of the W-scores, we selected all of the common data we had available that had been processed by different algorithms—the multi-biometric BSSR1 data and the CBIR “Corel Relevants” data. A selection of different fused two-algorithm combinations were tried. For comparison, we applied the popular z-score over the same algorithm pairs, and noted that for both sets, the W-scores consistently outperformed the z-scores (both normalization techniques were able to lift the recognition scores above the baselines for each algorithm being fused). CMCs for these experiments are shown in FIGS. 15 & 16.

### 5 Machine Learning-Based Methodology

Despite the underlying EVT statistical analysis using the raw scores, using them as direct feature vectors for machine learning based post-recognition score analysis does not work well. Thus, we pre-process the data to extract a set of features from. Those skilled in the art will see how to define a broad range of features whose characteristics might be better suited to a particular problem instance. initial process is very similar to the statistical meta-recognition process. We derive each feature from the distance measurements or similarity scores produced by the matching algorithm. Before we calculate each feature, we sort the scores from best to worst. The top k scores are used for the feature vector generation. We consider three different feature classes:
1. Δ_{1,2} defined as (sorted-score₁−sorted-score₂). This is the separation between the top score and the second best score.
2. Δ_{i,j . . . k} defined as ((sorted-scoreᵢ−sorted-scoreⱼ), (sorted-scoreᵢ−sorted-scoreⱼ₊₁), . . . , (sorted-scoreᵢ−sorted-scoreₖ)), where j=i+1. Feature vectors may vary in length, as a function of the index i. For example, Δ_{1,2 . . . k} is of length k−1, Δ_{2,3 . . . k} is of length k−2, and Δ_{3,4 . . . k} is of length k−3.
3. Discrete Cosine Transform (DCT) coefficients of the top-n scores. This is a variation on [16], where the Daubechies wavelet transform was shown to efficiently represent the information contained in a score series.

### 5.0.1 Building and Using Predictors

First, we must collect the necessary training data to build a classifier that will serve as our predictor. This includes the same number of samples for both positive match instances (correct rank-1 recognition), and negative match instances (incorrect rank-1 recognition), with sequences of scores from the recognition system for both. One embodiment uses these scores as the source data for the features. The resulting feature vectors are tagged (positive or negative) for an SVM training module, which learns the underlying nature of the score distributions. In practice, a radial basis kernel yields the best results for this sort of feature data derived from scores. Linear and polynomial kernels were also tried, but did not produce results as accurate as the radial basis kernel.

Unlike the statistical meta-recognition embodiments where we have per instance classifiers, Machine-learning embodiments use classifiers trained on multiple recognition instances. While the feature computation does have a normalizing effect on the underlying data, it does not re-articulate the scores in a generalized manner. Past failure prediction schemes [10, 16, 17, 23, 22] have trained a classifier for each recognition algorithm being considered, using some particularly set of features based upon the scores from that algorithm only. This invention uses more general approach fusing different feature sets for the same algorithm as well as different algorithms or modalities. It applies across more modalities and as we shall see the new fusion increase accuracy of prediction. During live recognition, we can compute a plurality of feature vectors from the resulting scores, and simply perform the meta-recognition using the SVM.

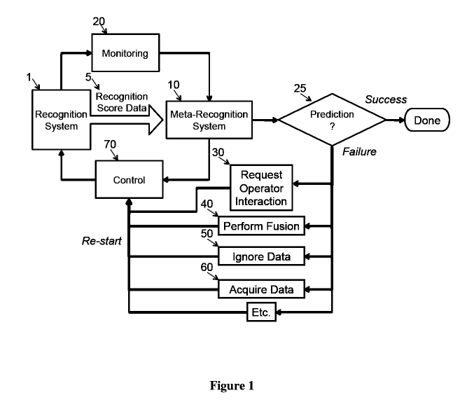

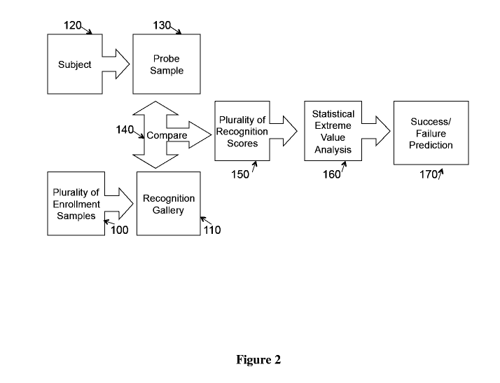

The result of success/failure prediction need not be a binary answer as was shown in the simplified model of FIG. 1. While a recognition result must be either a success of failure, it is quite possible that there is insufficient information on which to make a reasoned judgment. If one trains classifiers for success and a separate classifier for failure, one can still have a set of data in the middle for which they could disagree because there is insufficient data to make a good decision. The marginal distance of the SVM provide a simple way to estimate confidence in the meta-recognition systems success/failure prediction. Those skilled in the art will be able to determine confidence estimates for other types of machine learning.

One can expand the concept to also support perturbations in the enrollment or probe samples (input data) or in the scores and then compute marginal distances for each of the resulting plurality of feature vectors, and fuse the results combining the marginal distances or other quality measures derived from them. Perturbations offer the ability to do fusion from a single image and the many different features that can be derived from it. While the information have been inherent in the original data, the perturbations and different features sets computed from the recognition scores expose information in ways that can make it easier for a machine learning process to use.

Given the above discussion, an embodiment can train an SVM classifier using Algorithm 2. Those skilled in the art will see how other Machine learning could just as easily be applied. For rank-1 meta-recognition, one embodiment uses Algorithm 3.

Algorithm 2 Rank-1 Machine Learning Training.

Require: A collection of similarity score sets S₁⁺,...,Sₙ⁺ where the best
score is a correct match
Require: A collection of similarity score sets S₁⁻,...,Sₙ⁻ where the best
score is an incorrect match

| | |
|---|---|
| 1: | while i < n do |

| | |
|---|---|
| 2: | Sort the scores, s₁,...,sₙ ∈ Sᵢ⁺; |
| 3: | Compute feature f from Section 5 using s₁,...,sₙ; tag ‘+1’ |
| 4: | Sort the scores, s₁,...,sₙ ∈ Sᵢ⁻; |
| 5: | Compute feature f from Section 5 using s₁,...,sₙ; tag ‘−1’ |
| 6: | i ← i + 1 |

| | |
|---|---|
| 7: | end while |
| 8: | Train an SVM classifier using all 2n tagged feature vectors |

Algorithm 3 Rank-1 Machine Learning Meta-Recognition.

Require: A collection of similarity scores S

| 1: Sort the scores, s₁,...,sₙ ∈ S; | |
|---|---|
| 2: Compute feature f from Section 5 using s₁,...,sₙ | |
| 3: Classify using the trained SVM from Algorithm 2 | |
| 4: if class-label ≧ 0 then | |
| 5: | Predict Success |
| 6: else | |
| 7: | Predict Failure |

8: end if

While we have shown this for rank-1, i.e. the best score, given the associated ground-truth it is easily generated to any subset of ranks, e.g. rank-2 can disregard the top element and apply the above “rank-1” approach to estimate rank-2 results. Alternatively the SVM could be trained with an added dimension of the rank. Those skilled with other types of machine learning will see how both rank-1 and rank-n can be obtained via many different learning methods including variations of support-vector machines, variations on boosting, neural nets or other techniques.

### 5.0.2 Feature Fusion

Decision level fusion is defined as data processing by independent algorithms, followed by the fusion of decisions (based upon the calculated results) of each algorithm. This idea can be thought of as n different inputs to n different algorithms, producing n decisions that are combined together to produce a final decision that the system will act upon. The power of decision level fusion for meta-recognition stems from our need to combine data over independent recognition algorithms, as well as independent score features over meta-recognition. Ultimately, an embodiment may desire to provide a final decision on whether or not the probe was correctly recognized.

Moving towards lower levels within the system, we can fuse the recognition algorithm results before meta-recognition. Previous work in failure prediction has use features and addressed fusion across different inputs, the present invention includes fusion across the type of internal features. Again the information needed for meta-recognition may have been inherent in the data, but the goal of fusion here is to extract the information in a way that make it practical for machine-learning to build better predictions. We can also fuse across all score features before or after meta-recognition. In the following, we describe each fusion technique we use to enhance the accuracy of machine learning meta-recognition. Those skilled in the art will see many different types of features and ways to fuse these features during the prediction process for a particular problem and to help extract or decorrelate information. For example, if there was reason to believe a either a periodic nature or linear nature of the data, features could be designed that decorrelate on those two dimensions. In the following, [symbol] is a threshold, and Φ is one of the features in Section 5.
Threshold over all decisions d across features: [symbol] (d(Φ₁), d(Φ₂), . . . , d(Φₙ)). With this technique, we set a single threshold over meta-recognition decisions across features for a single algorithm, or for meta-recognition decisions across algorithms.
Individual thresholds across all decisions across score features:
( [symbol] (d(Φ₁)), [symbol] (d(Φ₂)), . . . , [symbol] (d(Φₙ))). With this technique, we set individual thresholds for each meta-recognition decision across features for a single algorithm, or for meta-recognition decisions across algorithms.
Combine data from one or more algorithms: This technique was used effectively in [25], with some information from one or more algorithms enhancing the performance of another algorithm when added to the data used for its feature computation. Fusion here takes place before score feature generation for meta-recognition, with one feature Φ applied to each individual algorithm in the combined data.
Consider a superset of score features: This technique treats the superset as part of one feature vector, combining the feature vectors that have been calculated for individual features before meta-recognition. This blending is an attempt to lift the performance in the machine learning by enhancing classification with longer, and ideally more distinct, feature vectors.

TABLE 1
Data breakdown for machine learning meta-recognition.
Testing and training data is per algorithm
(some sets contain more than 1 algorithm)

| Data Set | Training Samples | Test Samples | Recog. Algs. |
|---|---|---|---|
| BSSR1 | 600 | 200 | 2 Face & 1 Finger |
| BSSR1 “chimera” | 6000 | 1000 | 2 Face & 1 Finger |
| ALOI | 200 | 180 | SIFT |
| “Corel Relevants” | 300 | 200 | 4 CBIR |

### 5.1 Machine Learning Meta-Recognition Results

We demonstrate the effectiveness of the one embodiment of the machine learning meta-recognition with two goals. First, to show the accuracy advantage of the fusion techniques over the baseline features for meta-recognition; and second, to show the accuracy advantage of machine learning meta-recognition over statistical meta-recognition. Table 1 shows the data used for experimentation, including training and testing breakdowns, as well as the specific recognition algorithms considered. We note that this data is identical to that of Section 4, but with partitioning because of the need for training and testing data.

For the first round of experiments, the NIST multi-biometric BSSR1 data set was used. The subset of this data (fing_x_face) set that provides true multi-biometric results is relatively small for a learning test, providing match scores for 517 unique probes across two face (labeled C & G) recognition algorithms, and scores for two fingers (labeled LI & RI) for one fingerprint recognition algorithm. In order to gather enough negative data for training and testing, negative examples for each score set were generated by removing the top score from matching examples. In order to address the limited nature of the multi-biometric BSSR1 set, we created a “chimera” data set from the larger face and finger subsets provided by BSSR1, which are not inherently consistent across scores for a single user. This chimera set is artificially consistent across scores for a single user, and provides us with much more data to consider for fusion.

Results for a selection of data across both the true multi-biometric and Chimera sets, all algorithms, are presented as MRET curves in FIGS. 17 & 18. Single threshold fusion and individual thresholds fusion (FIG. 17), as well as algorithm blending fusion across modalities (FIG. 18) improve the performance of meta-recognition, compared with the baseline features. Feature blending fusion (not plotted) produced results as good as the best performing feature, but never significantly better. Different combinations of blending were attempted including mixing all features together, as well as different subsets of the features. While not improving meta-recognition performance, this fusion technique implicitly predicts performance as well as the best performing feature, without prior knowledge of the performance of any particular feature. Comparing the results of the multi-biometric BSSR1 data in FIGS. 17(a) & 18(b) to the statistical meta-recognition results in FIG. 11(a), we see that the baseline feature results of FIG. 17(a) are comparable, and that the baseline results of FIG. 18(b) are better; both FIGS. 17(a) & 18(b) show superior accuracy after fusion.

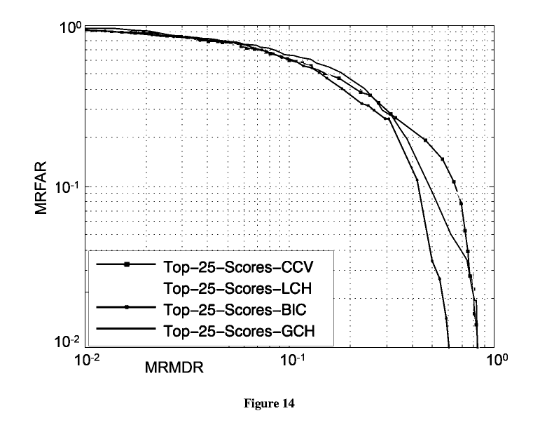

As in the evaluation of the statistical meta-recognition, and to support better comparison of the two embodiments, we tested a series of popular object recognition algorithms using the machine learning approach. For SIFT, we utilized all features except DCT (There is no expectation of scale/frequency information helping for this probe and experiments did show DCT did not yield results better than random chance for our data). The results of FIG. 19(a) show a significant increase in accuracy for the fusion techniques, as well as a significant increase in accuracy over the statistical meta-recognition of FIG. 14(a). For our four CBIR algorithms, we utilized all features except for Δ_{3,4, . . . 10}. Fusion results aside, even the best baseline feature results of FIG. 19(b) for CBIR descriptor GCH show better meta-recognition performance than the statistical meta-recognition of FIG. 14(b) in each case. We also ran experiments for BIC, CCV and GCH, which are not shown, and observed a similar performance gain.

When considering the feature level single threshold and individual thresholds fusion approaches, the results for all algorithms are significantly enhanced, well beyond the baseline features. Thus, the feature level fusion approach produces the best meta-recognition results observed in all of our experimentation. Since the cost to compute multiple features is negligible, the feature level fusion can easily be run for each meta-recognition attempt in an operational recognition system.

### 6 From Pure Statistics to Machine Learning

At this point, we have described two major classes of embodiments, the statistical meta-recognition and the machine learning meta-recognition. Each describes a wide range of possible embodiments with relative advantages and disadvantages. What are the differences/advantage. First, there is a difference in the underlying features provided to each system—the machine learning uses computed features from the recognition scores, while the statistical prediction uses the scores themselves. Second, when used on the same problem/data our experiments show the learning generally produce more accurate results (for example, FIG. 14(b) vs. FIG. 19(b)). The cause for these differences is directly related to the nature of the score distributions we consider as our data.

To address the use of computed features from the recognition scores, we can understand these features to have a normalizing effect upon the data. The GEV distribution is a 3-parameter family: one parameter shifting its location, one its scale and one that changes its shape. The EVT theory provides the reason why the learning approach is successful. The learning can develop an implicit overall Weibull shape parameter, ignoring any shift since the learning features are shift-invariant, and test the outlier hypothesis effectively. The failure of the learning approach on the raw data is likely caused by the shifting of the distribution of the non-match scores [symbol] (p) as a function of the probe p. The operation of our learning technique, where we consider an n-element feature space composed of k-dimensional feature data from matching and non-matching scores, is just a corollary to EVT, adapted to the recognition problem.

The difference in accuracy between the EVT-based prediction and the learning based prediction requires a deeper investigation of the underlying data produced by recognition systems. By definition, EVT distributions make an assumption of independence in the data [1], with no advantage given when fitting is performed over data that is dependent. The learning makes no assumptions about the underlying data, and can learn dependencies implicit in the data to its advantage. For the recognition problem, we always have dependent data to consider. Considering a series of probe input distributions, p₀, p₁, . . . , pₙ, for any probability Pr(pₓ=p_{c}*), that probability is always dependent on pₓ. It is this observation that explains the learning's advantage, in many cases, over the EVT-based prediction.

To demonstrate the learning's accuracy advantage in a controlled manner, we generated a set of simulated data representing both independent and dependent data. The independent data was generated by randomly sampling from two Gaussians with μ₁=0.7 and μ₂=0.2. Candidates for “positive” feature vectors included vectors with at least one sample from the Gaussian with mean μ₁, representing scores from the “match” distribution. Candidates for “negative” feature vectors included vectors with samples only from the Gaussian with mean μ₂, representing the “non-match” distribution. The dependent data was generated by using two different models of dependency. The first model represents a strong dependency on the means and standard deviations of two Gaussians, where μ=0.7 and σ=0.25. The first Gaussian simulating the “match” distribution is defined as [symbol] (μ, σ), while the simulated “non-match” distribution is defined as [symbol] (1−μ, 1−σ), establishing the dependency relationship to the first Gaussian. Construction of the feature vectors follows in the same manner as the independent data. The second model represents weaker dependency whereby the mean of the simulated “non-match” distribution is chosen by randomly sampling another Gaussian which has a mean that is dependent on the mean of the simulated “match” distribution. For the simulated “match” distribution in this case, we sample from [symbol] ₁( [symbol] ₂(μ, σ₁), σ₁), and [symbol] ₁( [symbol] ₂(1−μ, σ₂), σ₂) for the simulated “non-match” distribution, where σ₁=0.25 and σ₂=0.23. The machine learning classifiers were trained with 300 feature vectors computed from feature 2 of Sec. 5 (considering the top 10 scores), and tested with 200 feature vectors, while the Weibull predictor considered a tail of size 50 for each sample.

The results in FIG. 20 strongly support our hypothesis. There is a clear accuracy advantage as both the weak and strong dependencies are learned by the machine learning-based meta-recognition approach, as compared to the statistical meta-recognition. Both approaches are roughly comparable for meta-recognition applied to data that is purely independent, with a slight advantage for the machine learning. This is likely due to a very weak form of dependence that is introduced when Feature 2 from Sec. 5 is computed for the machine learning (Δs dependent on i). As it is clear the recognition problem will always produce dependent data, the machine learning approach, with fusion becomes very attractive for the meta-recognition application.

1. A method of meta-recognition comprising the steps of:
capturing an enrollment sample for each of a plurality of items to form a recognition gallery;
capturing a probe sample of a subject;
comparing the probe sample to the plurality of enrollment samples in the gallery to form a plurality of recognition scores;
performing an statistical extreme value analysis on a set of the plurality of recognition scores; and
providing a success/failure prediction for a plurality of the recognition scores based on the statistical extreme value analysis.

2. The method of claim 1, further including the steps of:
capturing a second probe sample from a same target as the probe sample;
performing a second statistical extreme value analysis on a second plurality of recognition scores associated with the second probe sample; and
based on the statistical extreme value analysis and the second statistical extreme value analysis determining a fusion of the plurality of recognition scores and the second plurality of recognition scores for determining the identity of the probe.

3. The method of claim 2, wherein the fusion is to only use the recognition score for predicted more likely by the more probable statistical extreme value analysis.

4. The method of claim 2, wherein the step of capturing the second sample data includes the step of perturbing the sampling process of the subject.

5. The method of claim 1 where the samples include biometric measurements of the subject.

6. The method of claim 2, wherein the fusion is a fusion of modalities for the biometric probe and the second biometric probe.

7. The method of claim 1 wherein the step of providing a success/failure prediction includes a normalization of recognition scores.

8. A method of meta-recognition comprising the steps of:
capturing an enrollment sample for each of a plurality of items, to form a recognition gallery;
capturing a plurality of training probe samples;
applying a machine learning technique to the plurality of training probe samples and the recognition gallery to obtain a classifier;
capturing a probe sample;
comparing the probe sample to the enrollment samples in the recognition gallery to form a plurality of recognition scores;
processing a portion of the plurality of recognition scores to form a plurality of similarity score features
processing the plurality of similarity score features with the classifer; and
providing a success/failure prediction for a plurality of the recognition scores.

9. The method of claim 8, wherein the selection of training probe samples are such that they capture statistical dependence between the plurality of similarity score features, which is then compensated for by the machine-learning to provide a success/failure measure with better performance than a statistical extreme value analysis-based predictor.

10. A method of claim 8 where the samples are biometric measurements.

11. The method of claim 8, wherein the step of training the machine learning technique includes the step of determining, for each of the plurality of training probe samples, a confidence measure for the recognition scores.

12. The method of claim 7, wherein the step of applying the portion of the plurality of recognition scores to the machine learning technique, includes the step of creating a difference between each of the portion of the plurality of recognition scores.

13. The method of claim 7, further including the steps of:
capturing a second probe sample from a same target as the probe sample;
determining a second success/failure prediction for a second recognition score associated with the second probe sample; and
based on the success/failure prediction and the second success/failure prediction determining a fusion of the recognition score and the second recognition score for determining the identity.

14. The method of claim 13, wherein the fusion is to only use the second plurality of recognition scores

15. The method of claim 13, wherein the samples are biometrics samples of an individual and the fusion is a fusion of modalities.

16. A method of meta-recognition comprising the steps of:
capturing an enrollment sample for each of a plurality of items, to form a recognition gallery;
capturing a first probe sample from a subject;
capturing a second probe sample from the same subject;
determining a plurality of first recognition scores for the first probe sample and a plurality of second recognition scores for the second probe sample; and
determining a first success/failure prediction for the first recognition scores and a second success/failure prediction for the second recognition scores; and
creating a fusion of the first recognition scores and the second recognition scores based on the first success/failure prediction and the second success/failure prediction.

17. The method of claim 16, wherein the step capturing the second probe sample includes the step of perturbing the first probe sample to create the second probe sample.

18. The method of claim 17, wherein the step of perturbing the first probe sample includes the step of receiving a perturbed metric for the second probe sample.

19. The method of claim 18, further including the steps of:
receiving an unperturbed metric for the first sample; and
evaluating the perturbed metric and the unperturbed metric;
when an unperturbed quality of the unperturbed metric is greater than a perturbed quality for the metric of the second probe biometric, perturbing the first probe metric to form a third probe sample.

20. The method of claim 19, further including the step of: when the unperturbed quality is not greater than the quality for the perturbed metric, selecting the perturbed metric.
